(19) United States
(12) Patent Application Publication
(10) Pub. No.: US 2020/0250980 A1
(43) Pub. Date: Aug. 6, 2020

(54) Reuse of Surroundings Models of Automated Vehicles

(71) Applicant: Robert Bosch GmbH, Stuttgart (DE)

(72) Inventors: Robert Harbach, Stuttgart-West (DE); Benjamin Hoeferlin, Pleidelsheim (DE)

(21) Appl. No.: 16/783,290

(22) Filed: Feb. 6, 2020

(30) Foreign Application Priority Data
Feb. 6, 2019 (DE) 10 2019 201 484.4

(51) Int. Cl. G08G 1/16; H04W 4/46; G05D 1/00; G06K 9/00

(52) U.S. Cl. CPC G08G 1/16; H04W 4/46; G05D 2201/0213; G05D 1/0055; G06K 9/00791; G05D 1/0088

(57) ABSTRACT

A method provides and transmits surroundings models and/or sensor data between at least two vehicles having the same or different automation levels by way of at least one controller. A first vehicle determines sensor data of its surroundings and creates a surroundings model for its own use. The created surroundings model and/or the sensor data of the first vehicle are transmitted for use to at least one second vehicle via a communication connection.

This application claims priority under 35 U.S.C. § 119 to patent application no. DE 10 2019 201 484.4, filed on Feb. 6, 2019 in Germany, the disclosure of which is incorporated herein by reference in its entirety.

The disclosure relates to a method for providing and transmitting surroundings models and/or sensor data, to a method for receiving and reusing surroundings models and/or sensor data, to a controller and to a device.

### BACKGROUND

Various sensors are used in automated vehicles to detect and classify static and dynamic objects. By way of example, camera sensors, radar sensors, ultrasound sensors and inertial sensors are used. These sensors make it possible to model the immediate local surroundings of the vehicles, which are often combined with map data. It is thereby made possible for the vehicles to implement long-term driving maneuvers.

The degree of detail of the surroundings model may vary depending on the automation level of the vehicle. Manually controlled vehicles or vehicles having a low degree of automation are not usually able to take advantage of complex surroundings models of fully automated vehicles.

### SUMMARY

The object on which the disclosure is based may be considered that of proposing a method for providing surroundings models to vehicles having a low degree of automation.

This object is achieved by way of the respective subject matter of the independent claims. Advantageous refinements of the disclosure are the subject matter of respective dependent sub-claims.

According to one aspect of the disclosure, what is provided is a method for providing and for transmitting surroundings models and/or sensor data. The method may be performed by at least one controller between at least two vehicles having the same or different automation levels.

In one step, a first vehicle determines sensor data of its surroundings and creates a surroundings model for its own use.

The created surroundings model and/or the sensor data of the first vehicle are/is transmitted for use to at least one second vehicle via a communication connection. The first vehicle may preferably have an automation level the same as and/or different from the second vehicle.

According to a further aspect of the disclosure, what is provided is a method for receiving and reusing surroundings models and/or sensor data. The method may be executed by at least one controller between at least two vehicles having the same and/or different automation levels. A surroundings model created by a first vehicle is received by at least one second vehicle for its own use via a communication unit and/or forwarded to at least one third vehicle via the communication connection.

According to a further aspect of the disclosure, what is provided is a device, in particular for a manually controlled vehicle. The device serves to create a communication connection to at least one controller and to receive sensor data and/or surroundings models, wherein the received sensor data and/or the surroundings model are/is received by at least one first vehicle or one second vehicle. It is thereby possible to achieve a retrofit solution for vehicles without automation functions or with a low automation level. The device may preferably visually display the determined sensor data and/or surroundings models via an output unit and warn the driver for example about approaching vehicles that are outside of his field of view.

The device may be designed as a display system and/or as a warning system. The device may furthermore have an intervening function. For this purpose, the device may for example have access to braking devices of the vehicle.

According to a further aspect of the disclosure, what is provided is a controller, wherein the controller is configured so as to execute the method. The data of the surroundings model and/or the sensor data may in particular be used by the controller to control a vehicle. Received sensor data and surroundings models may thus also be used to control the vehicle.

What is also provided according to one aspect of the disclosure is a computer program that comprises commands that, when the computer program is executed by a computer or a controller, prompt same to execute the method according to the disclosure.

According to a further aspect of the disclosure, what is provided is a machine-readable storage medium on which the computer program according to the disclosure is stored.

The controller may for example be installed in a vehicle. The vehicle may in this case be able to be operated in an assisted manner, in a partly automated manner, in a highly automated manner and/or in a fully automated or driverless manner, in accordance with the BASt [German Federal Highway Research Institute] standard.

Vehicles may be assigned to the automation levels of the BASt standard. As the automation level increases, the number of sensors that are used and thus the level of detail of the recorded surroundings increases. By way of example, at least one front sensor for accident avoidance is installed in assisted vehicles.

By virtue of the methods, it is possible to exchange and reuse sensor data from the surroundings sensors of vehicles starting from the assisted automation level. It is in particular possible to transmit sensor data and/or previously created surroundings models to other vehicles and in particular to vehicles with a lower automation level. As a result, vehicles with a low automation level, such as for example manually controlled, assisted, partly automated, are able to take advantage of vehicles with a higher automation level, such as for example highly automated and fully automated.

The method may in particular be implemented so as to reuse external sensor data in order to enrich local surroundings models. In this case, the sensor data and the surroundings models may be expanded by way of a plurality of traffic participants. As a result, it is possible to map a relatively large area in the form of a surroundings model, wherein the surroundings model goes beyond the limits of a vehicle sensor system.

It is thus possible to take into consideration concealed objects, which are not detected from the perspective of a vehicle, as well as objects that are situated beyond the reception radius of the sensors, for accident avoidance purposes. As a result, it is possible to achieve safety-relevant aspects in traffic, such as safe braking ahead of pedestrians, as well as comfort-relevant aspects, such as for example predictive driving.

According to one embodiment, sensor data and/or surroundings models of a parked vehicle are provided to the at least one second vehicle or the at least one first vehicle via the communication connection. The sensors of a vehicle in standby mode or of a parked vehicle are thus able to be used by neighboring vehicles. As a result, it may be made possible for example to expand the field of view in unpredictable traffic situations, such as merging into moving traffic with a restricted view.

According to a further embodiment, at least one dynamic and/or static object of the surroundings model created by the first vehicle are/is transmitted to the at least one second vehicle or to at least one third vehicle via the communication connection. Instead of completely exchanging entire surroundings models, it is possible to exchange individual objects with corresponding attributes, such as for example object position and object type. In particular in safety-critical segments or sections and when updating consolidated surroundings models of a section, the amount of data to be transmitted is able to reduced and the update speed of the expanded surroundings model is able to be increased by exchanging individual objects or sections of the surroundings model.

In order to exchange the sensor data and the resulting static and dynamic objects, the following requirements may preferably be met:
the coordinate system is known to all traffic participants
the traffic participants know their relative or absolute position
the time system is known to all traffic participants or the participants are in temporal synchronicity with one another.

According to a further refinement, the surroundings model is divided into at least two segments. The surroundings model preferably has at least one safety-relevant segment and at least one comfort-relevant segment. Data consumption and computational expenditure are thereby able to be reduced since the respective segments burden the controllers and the computational power of the vehicles to different extents.

According to a further refinement, the safety-relevant segment has a higher degree of detail than the comfort-relevant segment. The safety-relevant segment preferably has a temporal validity that is designed to be shorter than a temporal validity of the comfort-relevant segment. It is thereby possible to create the safety-relevant segment more frequently. The safety-relevant segment is optimally designed to be smaller than the comfort-relevant area and is calculated for example approximately in real time. The segments may be designed to be circular or concentric in the manner of an oval around the respective vehicle. The safety-relevant segment may for example be defined such that there is a real-time response by the vehicle to each event in the safety-relevant segment. This takes place depending on the speed. The radii or surface areas of the segments may thus be set according to speed.

According to a further refinement, the sensor data and/or the surroundings model of the first vehicle may be transmitted to the at least one second vehicle depending on distance. When the distance between the vehicles falls below a predefined distance, the data are thereby able to be shared or exchanged automatically between the vehicles. Depending on the degree of automation of the vehicles that are involved, the exchange of the sensor data and/or of the surroundings model may take place bidirectionally or in a one-way manner from the first vehicle to the at least one second vehicle. An extent of the data, to be transmitted, of the safety-relevant segment and/or of the comfort-relevant segment is preferably defined depending on a distance between the first vehicle and the at least one second vehicle. In this case, only data of the comfort-relevant segment may be transmitted starting from a distance between the vehicles and, when a further distance is fallen below, as an alternative or in addition, the data of the safety-relevant segment may be transmitted. The distance between the vehicles may be designed for example in the form of a radius or of a cone of the transmission device in order to create the communication connection. The distance may furthermore also be defined in the form of a signal strength, such that a larger amount of data of the safety-relevant segment is transmitted starting only from a sufficiently high signal strength.

According to a further refinement, the amount of sensor data and/or the level of detail of the transmitted surroundings model may be adjusted depending on the distance between the vehicles. As the distance becomes smaller, the sensor data and the surroundings model become increasingly safety-relevant, for which reason a larger amount of data and thus a higher level of detail is advantageous. In the case of a greater distance between the vehicles, the sensor data and/or the surroundings model may be exchanged or transmitted in order to perform comfort-relevant functions. In this case, the load on the communication connection may be reduced.

The respective distance or limit values as to whether a distance between the vehicles is safety-relevant or comfort-relevant may be defined on the basis of the segments of the surroundings model or on the basis of predefined values.

According to one embodiment, the received surroundings model is forwarded to at least one third vehicle. The third vehicle may be for example a manually controlled vehicle. As a result, even vehicles without automated functions are able to take advantage of the automation level of neighboring vehicles. Traffic safety is in particular able to be increased.

According to a further embodiment, the received surroundings model is adjusted on the basis of sensor data of the second vehicle. The received surroundings model is thereby able to be expanded by the sensor data of the second vehicle. Depending on the automation level of the second vehicle, the received surroundings model may be expanded by a separate surroundings model. It is thereby possible to create an expanded surroundings model mapping the surroundings from various perspectives and positions. The vehicles are thus also able to see past obstacles or around obstacles.

According to a further embodiment, the adjusted surroundings model of the second vehicle is transmitted to the first vehicle and/or to the at least one third vehicle. The original surroundings model of the first vehicle is thereby able to be updated. The third vehicle may receive an expanded surroundings model that contains sensor data of the second and of the first vehicle. Depending on the automation level of the second vehicle, it is also possible to transmit sensor data of the second vehicle to the first vehicle that may create an expanded surroundings model based on the sensor data of the second vehicle. The expanded surroundings model may then be transmitted to the second vehicle and to the third vehicle by the first vehicle.

The sensor data and/or the surroundings models are preferably transmitted via a wireless communication connection. The communication connection may be for example a car-to-car communication connection that is based on a WLAN, UMTS, LTE, GMS, 4G, 5G and the like transmission standard.

According to a further embodiment, the communication between at least two vehicles is performed via at least one vehicle and/or via at least one infrastructure unit and/or via a server unit. The transmission of the sensor data or of the surroundings models may thereby be implemented across a multiplicity of traffic participants. The relevant data may in particular be transmitted by way of what is known as a multi-hop method, in each case per vehicle or in the form of a vehicle chain. Since the surroundings model and the sensor data have a temporally limited validity, the transmission may be interrupted after a defined time, for example 5 minutes, or after a defined number of hops or vehicles.

According to a further refinement, sensor data are received from at least one infrastructure unit by at least one vehicle, wherein, based on the received sensor data of the infrastructure unit, a perception area of the at least one vehicle and/or a surroundings model are/is expanded. The use of stationary sensors, such as for example traffic lights, may thus be taken into consideration. A central server unit may furthermore receive sensor data of the at least one vehicle and create an expanded surroundings model, which is provided to the traffic participants, on the basis of a multiplicity of sensor data. Central creation of the surroundings model is thereby possible.

The recorded data may furthermore be used to update digital maps and to optimize a route plan with the aid of dynamic information from the sensor data determined based on the vehicle.

According to a further aspect of the disclosure, what is provided is a method for receiving and using sensor data and/or surroundings models by way of a controller. The sensor data and/or surroundings models are received from at least one first vehicle via a communication connection. The received sensor data and/or surroundings models are used by the controller and/or forwarded to at least one second vehicle and/or to at least one third vehicle via the communication connection.

The decision as to which transmitted data are used by the controller thus lies at the receiving vehicle. The transmitting vehicle is thus able to transmit all of the sensor data and data regarding its surroundings model to other vehicles or the receiving vehicle unhindered.

According to a further embodiment, the sensor data and/or surroundings model received by the at least one second vehicle are/is selectively used to expand the separate surroundings model. The controller of the at least one receiving vehicle is then able to filter or select the data received via the communication connection or forward them in unfiltered form. The received data may preferably be filtered such that gaps in a perception of the surroundings sensor system are filled by at least part of the received data. The sampling area of the receiving vehicle may thereby for example be expanded by objects and obstacles. By way of example, the vehicle may gain knowledge of a traffic event outside its sampling area based on the received data, and thus allow increased traffic safety.

Depending on the refinement, the transmitting vehicle may preselect or filter the sensor data and/or data of the surroundings model before transmission to other vehicles. The data may be selected in this way depending on geographical conditions or on the basis of a position on a map. By way of example, the distance to other vehicles, the visibility of the area and the like may be decisive for the transmission of the data in this case.

### BRIEF DESCRIPTION OF THE DRAWINGS

Preferred exemplary embodiments of the disclosure are explained in more detail below on the basis of greatly simplified schematic illustrations, in which

FIG. 1 shows a traffic situation in order to illustrate a method according to one exemplary embodiment,

FIG. 2 shows the traffic situation from FIG. 1 with surroundings models in order to illustrate a method according to the exemplary embodiment,

FIG. 3 shows a further traffic situation in order to illustrate a method according to a further exemplary embodiment, and

FIG. 4 shows a traffic situation in order to illustrate segmentation of a surroundings model.

### DETAILED DESCRIPTION

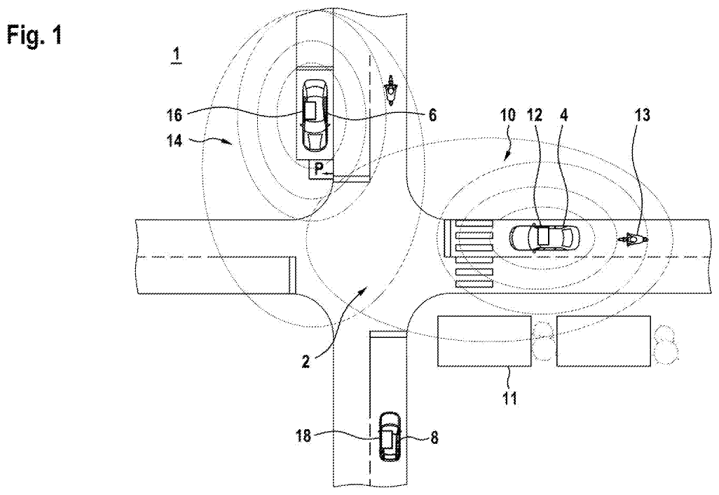

FIG. 1 shows a traffic situation 1 in order to illustrate a method according to one exemplary embodiment. Three vehicles 4, 6, 8 are arranged on a crossing 2.

A first vehicle 4 has a highly automated automation level and is thus equipped with a more extensive surroundings sensor system, this not being illustrated for the sake of simplicity.

The surroundings sensor system may sample the surroundings 10 of the first vehicle 4 and determine sensor data. The surroundings sensor system may for example have radar sensors, camera sensors, lidar sensors and the like. The sampling area of the surroundings sensor system 10 or the surroundings 10 is indicated by the concentric circles around the first vehicle 4.

The sampling area 10 of the first vehicle 4 is restricted by static objects 11 in the form of buildings. As a result, the first vehicle 4 is not able to determine that a further vehicle 8 is approaching the crossing 2.

A motorcycle, as a dynamic object 13, positioned behind the first vehicle 4, is able to be detected by the surroundings sensor system of the first vehicle 4.

The first vehicle 4 has a controller 12. The controller 12 serves for example to evaluate the sensor data.

A second vehicle 6 has a partly automated automation level. As a result, the surroundings sensor system of the second vehicle 6 is designed so as to be less extensive in comparison with the first vehicle 4. The surroundings 14 or the corresponding sensor range is illustrated in the same way as for the first vehicle 4.

The second vehicle 6 likewise has a controller 16. The controller 16 of the second vehicle 6 may be designed the same as or differently from the controller 12 of the first vehicle 4.

A third vehicle 8 is likewise approaching the crossing 2. The third vehicle 8 is controlled manually and does not have any surroundings sensors. The vehicles 4, 6, 8 thus all have a different automation level.

The third vehicle 8 has a device 18 that is configured so as to transmit and receive data.

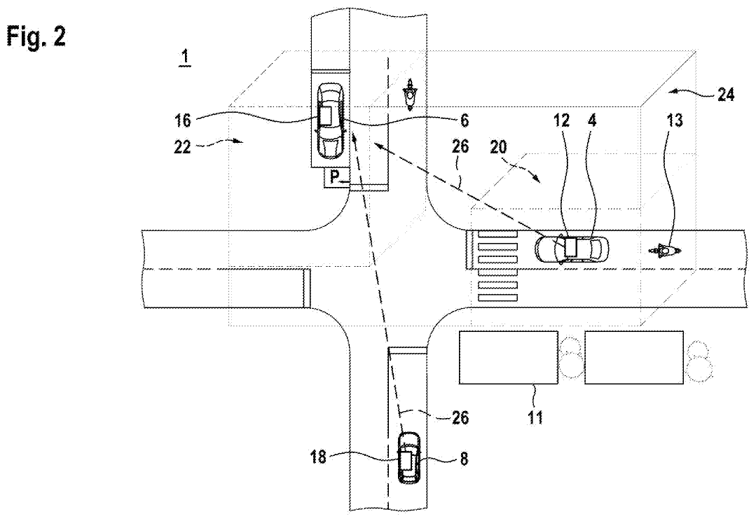

FIG. 2 shows the traffic situation from FIG. 1 with surroundings models 20, 22, 24 in order to illustrate a method according to the exemplary embodiment.

The controller 12 of the first vehicle 4 evaluates the sensor data and creates a first local surroundings model 20 of the surroundings 10.

The created surroundings model 20 of the first vehicle 4 is transmitted to the second vehicle 6 for use via a communication connection 26. The communication connection 26 may in particular be created in a wireless manner, for example via a car-to-car connection, between the controllers 12, 16.

The controller 16 of the second vehicle 6 likewise creates a separate surroundings model 22 based on the self-determined sensor data. In addition to this, the controller 16 receives the surroundings model 20 of the first vehicle 4 and fuses the two surroundings models 20, 22 to form an expanded surroundings model 24. The received surroundings model 20 may be transformed to the vehicle coordinates of the second vehicle 6. In the event of geographical intersections of the sensor data or of the surroundings models 20, 22, these may be fused with one another.

The communication connection 26 may be created in both directions such that the first vehicle 4 is able to receive the expanded surroundings model 24 from the second vehicle 6. The first vehicle 4 is thereby able to perceive the third vehicle 8.

The surroundings model 24 may for example contain local surroundings data with distances to the vehicle, vehicle type and the like. In this case, calculated trajectories and additional information of the vehicles 4, 6, 8, including vehicle parameters and specific driving strategies of vehicles 4, 6, 8, may also be contained in the expanded surroundings model 24 starting from a partly automated automation level.

The current vehicle positions of the vehicles 4, 6 may be exchanged with one another via the communication connection 26. The vehicle positions may in this case be determined relative to a map or in absolute terms through GNSS coordinates.

The expanded surroundings model 24 may then be sent to other traffic participants. The surroundings model 24 may in particular be transmitted to the device 18 of the third vehicle 8 via the communication connection 26. Said device 18 may receive the surroundings model 24 and assist the driver of the third vehicle 8.

When propagating the local surroundings models 20, 22, after a few exchange procedures or what are known as hops via the communication connection 26, a consolidated surroundings model 24 of a section 2 is achieved. Even if direct communication between the first vehicle 4 and the third vehicle 8 is not possible on account of the objects 11, the third vehicle 8 is able to be determined by way of the communication connection 26 and the forwarding of the expanded surroundings model 24. A warning or emergency braking in the event of a potential collision between the vehicles is thereby able to be initiated.

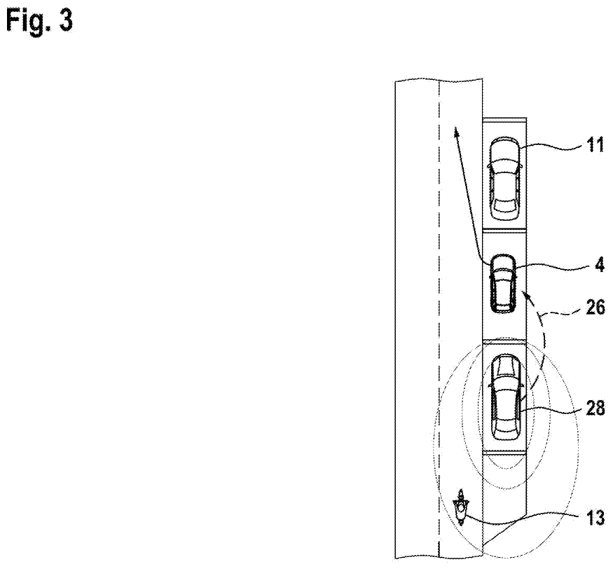

FIG. 3 shows a further traffic situation in order to illustrate a method according to a further exemplary embodiment. The procedure of leaving a parking space of the first vehicle 4 is in this case able to be facilitated by virtue of the sensor data of a parked vehicle 28 being received by the first vehicle 4 via the communication connection 26. As a result, the first vehicle 4 is able to determine the motorcyclist as a dynamic object 13 and adjust its trajectory. Visual concealment by the parked vehicle 28 is thereby in particular able to be circumvented.

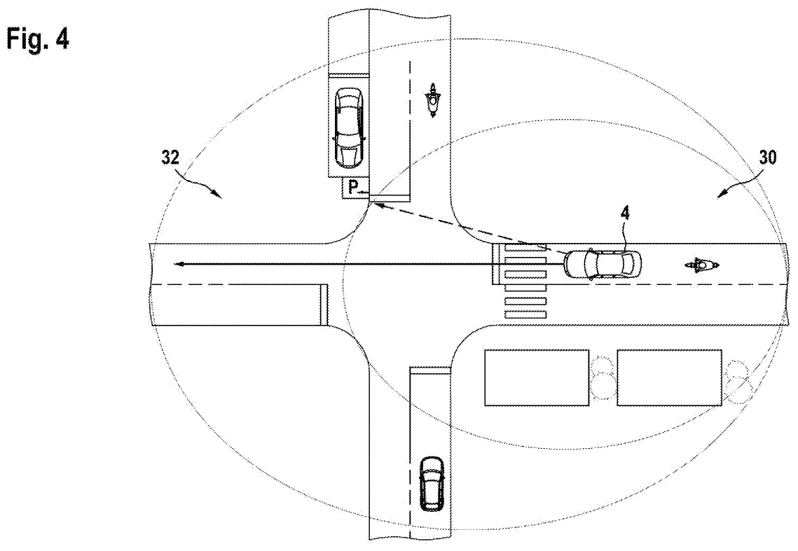

FIG. 4 shows a traffic situation in order to illustrate segmentation of a surroundings model 20. The surroundings model 20 in particular has two segments 30, 32 by way of example. The surroundings model 20 has a safety-relevant segment 30 and a comfort-relevant segment 32.

The safety-relevant segment 30 has a higher level of detail than the comfort-relevant segment 32 and has a smaller radius.

What is claimed is:

1. A method for providing and transmitting surroundings models and/or sensor data between at least two vehicles having the same or different automation levels, comprising:
determining, with a first vehicle, sensor data of surroundings of the first vehicle;
creating a surroundings model with a controller of the first vehicle based on the determined sensor data;
using the created surroundings model with the first vehicle;
transmitting the created surroundings model and/or the determined sensor data to at least one second vehicle via a communication connection between the first vehicle and the at least one second vehicle; and
using the transmitted surroundings model and/or the transmitted sensor data with the at least one second vehicle.

2. The method according to claim 1, further comprising:
transmitting to the at least one second vehicle sensor data determined by the first vehicle and/or surroundings models created by the first vehicle of a parked vehicle via the communication connection.

3. The method according to claim 1, further comprising:
transmitting at least one dynamic and/or static object of the surroundings model created by the first vehicle to the at least one second vehicle or to at least one third vehicle via the communication connection.

4. The method according to claim 1, further comprising:
dividing the surroundings model into at least two segments including at least one safety-relevant segment and at least one comfort-relevant segment.

5. The method according to claim 4, wherein:
the safety-relevant segment has a higher degree of detail than the comfort-relevant segment, and
the safety-relevant segment has a temporal validity that is shorter than a temporal validity of the comfort-relevant segment.

6. The method according to claim 4, further comprising:
defining an extent of the safety-relevant segment and/or of the comfort-relevant segment to be transmitted depending on a distance between the first vehicle and the at least one second vehicle.

7. A method for receiving and reusing surroundings models and/or sensor data between at least two vehicles having the same or different automation levels, comprising:
receiving a surroundings model created by a first vehicle with at least one second vehicle via a communication connection between the first vehicle and the at least one second vehicle; and
forwarding the received surroundings model to at least one third vehicle via the communication connection.

8. The method according to claim 7, further comprising:
using selectively sensor data and/or the received surroundings model to expand a separate surroundings model.

9. The method according to claim 7, further comprising:
adjusting the received surroundings model based on sensor data of the second vehicle.

10. The method according to claim 9, further comprising:
transmitting the adjusted surroundings model to the first vehicle and/or to the at least one third vehicle via the communication connection.

11. The method according to claim 7, further comprising:
communicating between at least two vehicles via at least one vehicle and/or via at least one infrastructure unit and/or via a server unit.

12. The method according to claim 7, wherein a controller is configured to execute the method.

13. The method according to claim 12, wherein a computer program comprises commands that, when the computer program is executed by the controller, prompts the controller to execute the method.

14. The method according to claim 13, wherein the computer program is stored on a machine-readable storage medium.

15. A device for a manually controlled vehicle, comprising:
a controller configured (i) to create a communication connection to at least one other controller, and (ii) to receive sensor data and/or surroundings models,
wherein the received sensor data and/or the surroundings model are received by at least one first vehicle or one second vehicle.
